(19) United States
(12) Patent Application Publication
(10) Pub. No.: US 2026/0160369 A1
(43) Pub. Date: Jun. 11, 2026

(54) FLUID CONNECTOR AND ASSEMBLY

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Hsiu-Yuan HSU, New Taipei (TW); Yao-Chi HUANG, New Taipei (TW); Wen HE, Shenzhen (CN); Ling TAO, Shenzhen (CN); Ling-Xiong LI, Shenzhen (CN); De-Qin LI, Shenzhen (CN)

(21) Appl. No.: 19/408,323

(22) Filed: Dec. 3, 2025

(30) Foreign Application Priority Data
Dec. 5, 2024 (CN) 202422993520.9

(51) Int. Cl. F16L 37/32

(52) U.S. Cl. CPC F16L 37/32

(57) ABSTRACT

A fluid connector assembly includes a fluid connector mounted on a plate and a matching connector configured to mate with the fluid connector. The fluid connector has a shell, a valve body, and a valve body spring. The shell has a main body with a cavity and a base integrally connected below the cavity. The main body has an opening formed upwardly and communicating with the cavity. The valve body spring supports the valve body. The valve body is inserted into an insertion hole provided in the base and is moveable relative to the insertion hole in an up-down direction. When the two connectors are disconnected, the valve body is supported by the valve spring to tightly seal the opening. When the two connectors are mated, the valve body is pushed downward to open the opening. The fluid connector has a simple structure and high precision.

### BACKGROUND OF THE INVENTION

### Field of the Invention

The present invention relates generally to a fluid connector and a fluid connector assembly including the fluid connector, and more particularly to a fluid connector and a fluid connector assembly with a simple structure and high precision.

### Description of Related Arts

Fluid connectors, such as China Patent No. 205896502, are typically used to mount to a plate and communicate fluid through pipelines on the plate. The fluid connector includes a shell, a valve body, and a valve body spring. The shell has a main body with a cavity and a supporting element assembled into the cavity. The upper end of the main body forms an opening that communicates with the cavity. The valve body includes a sealing portion that seals the opening and an insertion rod extending downward from the sealing portion, which is inserted into the supporting element. One end of the valve body spring supports the sealing portion of the valve body, while the other end supports the supporting element. The supporting element of the shell is assembled into the main body of the shell, so an additional sealing element is required between the supporting element and the main body. Furthermore, the shell is composed of two components: the main body and the supporting element. If the fitting precision between the main body and the supporting element is low, the sealing performance of the fluid connector cannot be ensured after the insertion rod is inserted into the supporting element. In addition, to prevent the supporting element from detaching from the main body, the supporting element must be supported by the plate. This requires the size of the supporting element to be larger than the pipeline on the plate, which inevitably increases the size of the fluid connector. This does not align with the miniaturization trend of fluid connector development.

### SUMMARY OF THE INVENTION

A fluid connector configured to mate with a matching connector comprises: a shell having a main body with an internal cavity and a base located below the cavity, the main body having an opening formed upward and in communication with the cavity, the base having an insertion hole and at least one through hole communicating with the cavity; a valve body movably engaged to the insertion hole; and a valve body spring received in the cavity for supporting the valve body; wherein the main body and the base are integrally connected; and when the fluid connector is not connected to the matching connector, the valve body is supported by the valve body spring to tightly seal the opening, and when the fluid connector is mated with the matching connector, the valve body is pushed downward to open the opening.

### BRIEF DESCRIPTION OF DRAWINGS

FIG. 1 shows a perspective view of a fluid connector and a matching connector according to the present disclosure;

FIG. 2 shows an exploded perspective view of FIG. 1 from another angle;

FIG. 3 shows an exploded perspective view of the fluid connector according to the present disclosure;

FIG. 4 shows an exploded perspective view of FIG. 3 from another angle;

FIG. 5 shows a cross-sectional schematic view of the fluid connector mounted on a first plate;

FIG. 6 shows a perspective view of the matching connector according to the present disclosure;

FIG. 7 shows a perspective view of FIG. 5 from another angle;

FIG. 8 shows a cross-sectional schematic view of the matching connector mounted on a second plate;

FIG. 9 shows a cross-sectional schematic view during mating of the fluid connector and the matching connector; and

FIG. 10 shows a cross-sectional schematic view after the fluid connector and the matching connector are fully mated.

### DETAILED DESCRIPTION OF THE DRAWINGS

Reference will now be made in detail to the preferred embodiments of the present invention.

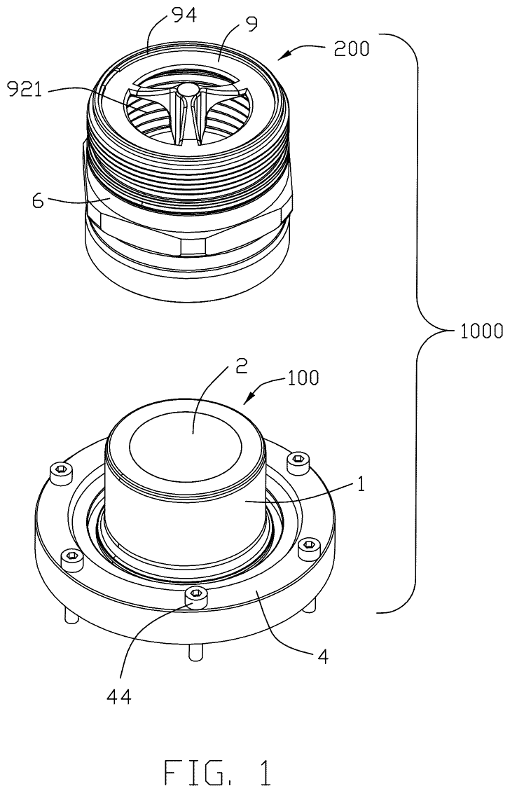

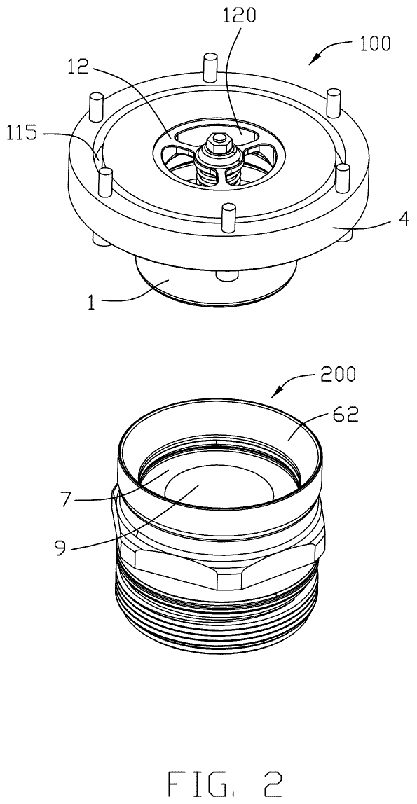

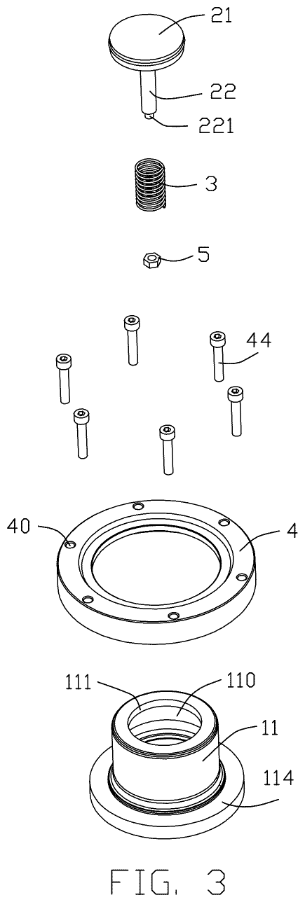

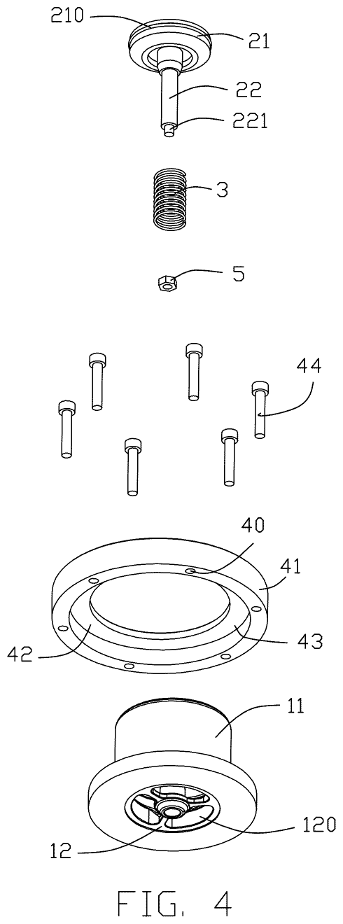

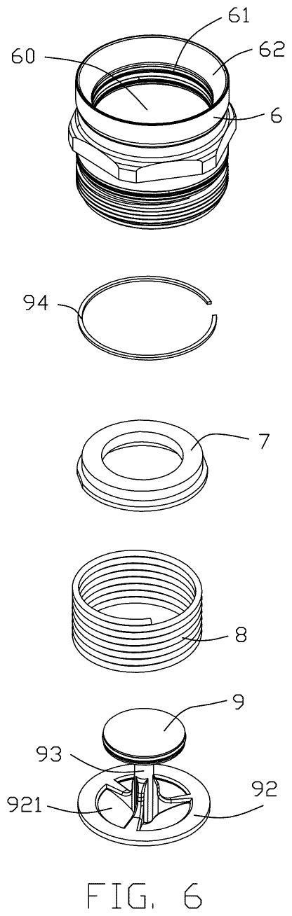

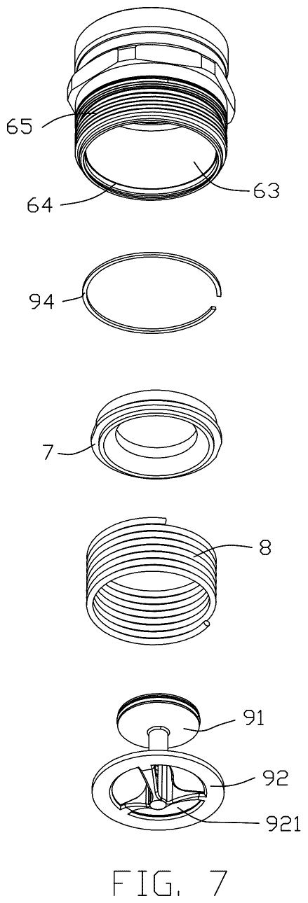

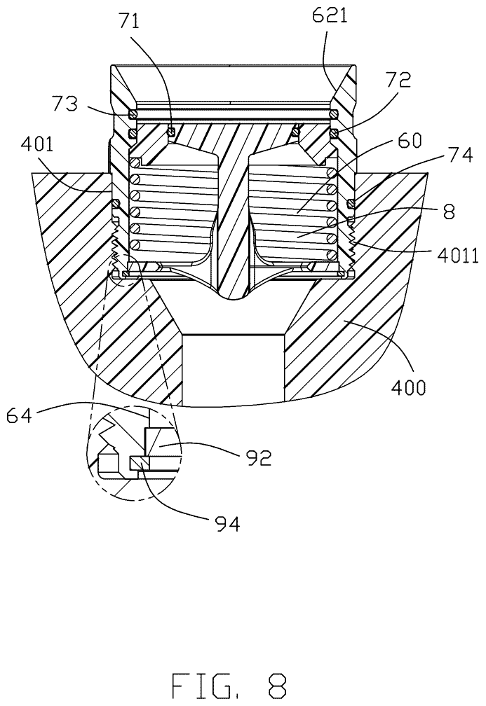

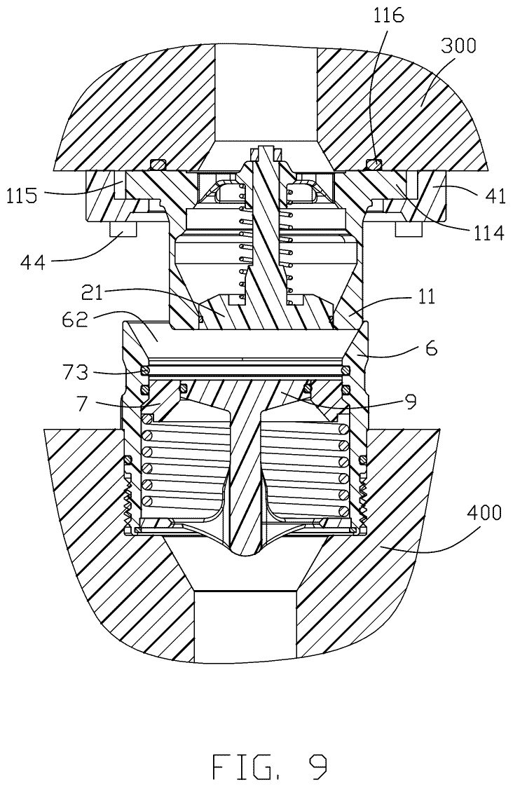

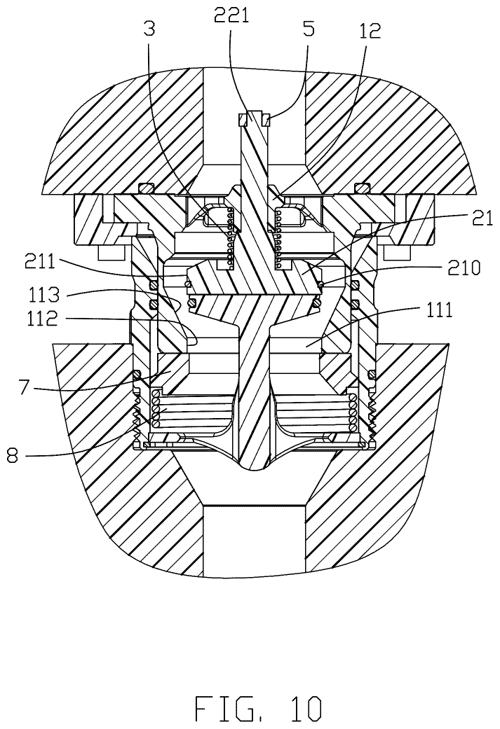

Referring to FIGS. 1-10 illustrating a fluid connector assembly 1000 of an embodiment of this present invention, the fluid connector assembly 1000 includes a fluid connector 100 and a matching connector 200 for mating with the fluid connector 100. The fluid connector 100 is fixed to a first plate 300, and the matching connector 200 is fixed to a second plate 400. The interior of the fluid connector 100 is a hollow structure and is in fluid communication with a pipeline formed on the first plate 300. Similarly, the interior of the matching connector 200 is also a hollow structure and is in fluid communication with a pipeline formed on the second plate 400.

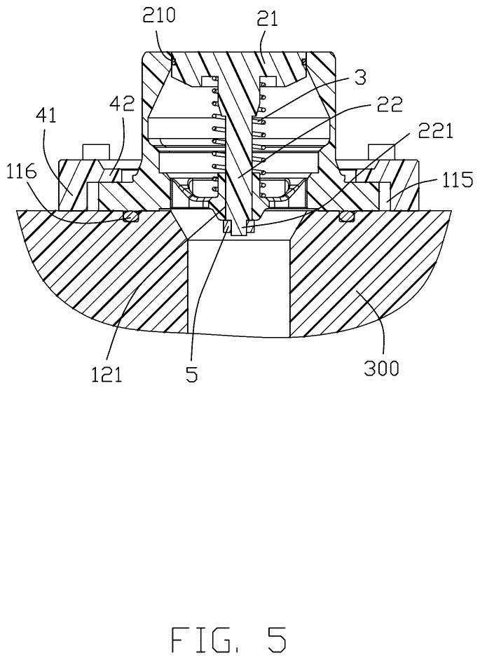

The fluid connector 100 includes a shell 1, a valve body 2, a valve body spring 3 supporting the valve body 2, and a fixing component 4 that secures the shell 1 to the first plate 300. The shell 1 includes a main body 11 with an internal hollow cavity 110 and a base 12 integrally connected to the main body 11 below the cavity 110. The main body 11 extends upward and forms an opening 111 in communication with the cavity 110. The base 12 has a through hole 120 that communicates with the cavity 110, allowing the pipeline formed in the first plate 300 to communicate with the cavity 110. The valve body spring 3 is received in the cavity 110 and supports the valve body 2, enabling the valve body 2 to move in a direction toward and away from the opening 111, such as the vertical direction in FIG. 5. This ensures that when the fluid connector 100 is not mated with the matching connector 200, the valve body 2 is supported by the valve body spring 3 to tightly seal the opening 111.

In this embodiment, the valve body 2 includes a sealing portion 21 at its upper end, which can seal the opening 111, and a cylindrical extension portion 22 extending downward from the middle of the sealing portion 21. The base 12 has an insertion hole 121 for the insertion of the extension portion 22. The valve body spring 3 is arranged around the extension portion 22, with one end supported by the base 12 and the other end supported by the sealing portion 21. This allows the extension portion 22 to move in a direction toward and away from the insertion hole 121. When the fluid connector 100 is not mated with the matching connector 200, the valve body spring 3 pushes the sealing portion 21 upward to tightly seal the opening 111. It should be noted that, to ensure a tight seal between the outer periphery of the sealing portion 21 and the inner wall surface of the main body 11, a sealing ring 210 is provided between the outer periphery of the sealing portion 21 and the inner wall surface of the main body 11. The sealing ring 210 can be tightly retained on the outer periphery of the sealing portion 21 and/or the inner wall surface of the main body 11 through grooves provided on the outer periphery of the sealing portion 21 and/or the inner wall surface of the main body 11. The main body 11 and the base 12 of the shell 1 of the fluid connector 100 are integrally formed as a single component. This not only provides the fluid connector 100 with reliable sealing performance but also ensures high fitting precision between the valve body 2 and the base 12, enabling the sealing portion 21 of the valve body 2 to reliably seal the opening 111.

When the fluid connector 100 is mated with the matching connector 200, the sealing portion 21 is pushed downward by the matching connector 200, opening the opening 111 while the extension portion 22 moves downward within the insertion hole 121. When the matching connector 200 is removed, to prevent the extension portion 22 from moving excessively upward and causing the sealing portion 21 to detach from the opening 111, the fluid connector 100 has a limiting component 5 to restrict the excessive upward movement of the extension portion 22. In the present invention, the extension portion 22 includes an extended portion 221 that extends downward through the insertion hole 121 and passes through the bottom of the base 12. The limiting component 5 is fixed to the extended portion 221 to restrict the excessive upward movement of the extension portion 22, thereby preventing the sealing portion 21 from detaching upward from the opening 111. The limiting component 5 is a nut, but it can also be a retaining ring, which may be a snap ring or other limiting component. Additionally, in other embodiments, the limiting component 5 can also be a limiting component provided inside the insertion hole 121, which can be a separate component installed inside the insertion hole or an integral part of the base.

In this embodiment, the valve body 2 is assembled into the main body 11 from the opening 111 in a top-down manner. The main body 11 has a vertical inner wall surface 112 and an inclined inner wall surface 113 connected to the vertical inner wall surface 112. The vertical inner wall surface 112 is parallel to the axial direction of the main body 11 and is positioned adjacent to the opening 111. The inclined inner wall surface 113 is located farther from the opening 111 and extends outward relative to the vertical inner wall surface 112. The outer periphery of the sealing portion 21 is a vertical outer peripheral surface 211 that closely fits against the vertical inner wall surface 112. A sealing ring 210 is provided between the vertical inner wall surface 112 and the vertical outer peripheral surface 211. When the sealing portion 21 is pushed downward by the matching connector 200 to the inclined inner wall surface 113, the opening 111 is opened and communicates with the cavity 110.

The fixing component 4 of the fluid connector 100 holds the main body 11 on the first plate 300, allowing the main body 11 to move in a radial direction perpendicular to the axial direction of the main body 11 relative to the fixing component 4. This enables the fluid connector 100 to have a blind-mating and position-adjusting function. Specifically, the shell 1 includes a flange 114 integrally extending outward from the lower end of the main body 11. The fixing component 4 is a fixing ring arranged around the main body 11. The fixing component 4 includes a vertically arranged ring wall 41 and a horizontally arranged upper wall 42 extending inward from the upper end of the ring wall 41. The flange 114 is accommodated in an internal space 43 formed by the ring wall 41 and the upper wall 42. The ring wall 41 is located outside the flange 114, and a gap 115 is formed between the ring wall 41 and the flange 114 to allow the flange 114 to move. The fixing component 4 is fixed to the first plate 300 by a holding element 44, which is a bolt fixed to the first plate 300 through a fixing hole 40 on the fixing component 4. The flange 114 is clamped between the lower surface of the upper wall 42 and the first plate 300 by the holding element 44. To ensure the sealing performance between the main body 11 and the first plate 300, a sealing ring 116 is provided between the flange 114 and the first plate 300.

In this embodiment, the matching connector 200 includes a matching shell 6, a matching valve body 7, a matching valve body spring 8 supporting the matching valve body 7, and a matching push rod 9. The matching shell 6 has a matching cavity 60 and has a matching opening 61 communicating with the matching cavity 60. The lower end of the matching push rod 9 is fixed to the lower end of the matching shell 6. The matching valve body 7 is an annular member arranged around the upper end of the matching push rod 9, and the matching valve body spring 8 supports the matching valve body 7. When the matching connector 200 is not connected to the fluid connector 100, the matching valve body 7 is supported by the matching valve body spring 8 and is tightly clamped between the matching push rod 9 and the matching shell 6, thereby sealing the matching opening 61. The upper end of the matching opening 61 of the matching connector 200 expands to form an expanded opening 62 with a guiding surface 621. When the fluid connector 100 and the matching connector 200 are blindly mated, the main body 11 of the fluid connector 100 is guided by the guiding surface 621 of the expanded opening 62 of the matching shell 6 to move and align relative to the fixing component 4. This causes the matching push rod 9 to abut against the sealing portion 21 of the valve body 2, and the main body 11 to abut against the matching valve body 7. Consequently, the sealing portion 21 of the valve body 2 moves axially within the main body 11 to open the opening 111, and the matching valve body 7 moves axially within the matching shell 6 to open the matching opening 61, thereby achieving fluid communication. The matching push rod 9 includes a top portion 91 at the upper end, a bottom portion 92 at the lower end, and a cylindrical rod portion 93 connecting the top portion 91 and the bottom portion 92. The matching valve body 7 is arranged around the periphery of the top portion 91. The bottom portion 92 has a matching through-hole 921 that communicates with the matching cavity 60, allowing the pipeline formed in the second plate 400 to communicate with the matching cavity 60. The matching shell 6 extends downward to form an assembly opening 63, and the matching push rod 9 is inserted upward into the matching shell 6 through the assembly opening 63. The matching push rod 9 is a stationary component relative to the matching shell 6. The lower end of the inner wall surface of the matching shell 6 has a boss 64 that limits the upward movement of the bottom portion 92 of the matching push rod 9. The lower end of the bottom portion 92 has a retaining ring 94 that is clamped inside the matching shell 6 to limit the downward movement of the bottom portion 92. The retaining ring 94 can be a snap ring. The matching valve body spring 8 is arranged around the outside of the matching push rod 9, with one end supported by the matching valve body 7 and the other end supported by the bottom portion 92 of the matching push rod 9. When the matching connector 200 is mated with the fluid connector 100, the main body 11 of the fluid connector 100 abuts against the matching valve body 7, causing the matching valve body 7 to move downward relative to the top portion 91 of the matching push rod 9, thereby opening the matching opening 61. The matching connector 200 is fixed to the second plate 400 by means of a threaded connection. The peripheral side of the lower end of the matching shell 6 has external threads 65. The second plate 400 has an assembly opening 401 for the insertion of the lower end of the matching shell 6. The inner circumference of the assembly opening 401 has internal threads 4011 that mate with the external threads 65. The matching shell 6 is screwed into the assembly opening 401. To ensure the sealing performance of the matching valve body 7, a sealing ring 71 is provided between the inner peripheral surface of the matching valve body 7 and/or the outer peripheral surface of the top portion 91 of the matching push rod 9. A sealing ring 72 is provided between the outer peripheral surface of the matching valve body 7 and/or the inner wall surface of the matching shell 6. This prevents fluid leakage between the matching valve body 7 and the matching push rod 9 and/or between the matching valve body 7 and the matching shell 6 when the matching connector 200 is not mated with the fluid connector. The matching shell 6 has a sealing ring 73 above the sealing ring 72. When the matching connector 200 is mated with the fluid connector 100, the shell 1 of the fluid connector 100 is located inside the matching shell 6 of the matching connector 200, the sealing ring 73 is used to seal the space between the shell 1 of the fluid connector 100 and the matching shell 6 of the matching connector 200 after the two connectors are mated. Additionally, a sealing ring 74 is provided between the peripheral side of the matching shell 6 and the inner circumference of the assembly opening 401. The sealing ring 74 is located above the threaded connection to prevent fluid from leaking outward from the threaded connection.

However, the disclosure is illustrative only, changes may be made in detail, especially in matter of shape, size, and arrangement of parts within the principles of the invention.

1. A fluid connector configured to mate with a matching connector, the fluid connector comprising:
a shell having a main body with an internal cavity and a base located below the cavity, the main body having an opening formed upward and in communication with the cavity, the base having an insertion hole and at least one through hole communicating with the cavity;
a valve body movably engaged to the insertion hole; and
a valve body spring received in the cavity for supporting the valve body; wherein
the main body and the base are integrally connected; and
when the fluid connector is not connected to the matching connector, the valve body is supported by the valve body spring to tightly seal the opening, and when the fluid connector is mated with the matching connector, the valve body is pushed downward to open the opening.

2. The fluid connector according to claim 1, wherein: the valve body has a sealing portion and an extension portion extending downward from the sealing portion and inserted into the insertion hole; one end of the valve body spring supports the base, and the other end supports the sealing portion; when the fluid connector is not connected to the matching connector, the sealing portion is pushed upward to seal the opening; when the sealing portion is pushed downward, the extension portion moves within the insertion hole; and the fluid connector has a limiting component to restrict the excessive upward movement of the extension portion, thereby preventing the sealing portion from detaching upward from the opening.

3. The fluid connector according to claim 1, wherein: the valve body has a sealing portion and an extension portion extending downward from the sealing portion and inserted into the insertion hole; one end of the valve body spring supports the base, and the other end supports the sealing portion; when the fluid connector is not connected to the matching connector, the sealing portion is pushed upward to seal the opening; when the sealing portion is pushed downward, the extension portion moves within the insertion hole; and the fluid connector has a limiting component attached to an end of the extension portion, and the limiting component and the sealing portion are at opposite sides of the insertion hole.

4. The fluid connector according to claim 2, wherein the extension portion has an extended portion that extends downward from the insertion hole of the base, and the limiting component is secured to the extended portion to restrict the sealing portion from detaching upward from the opening.

5. The fluid connector according to claim 2, wherein: the main body has a vertical inner wall surface parallel to the axial direction of the main body and adjacent to the opening, and an inclined inner wall surface connected to the vertical inner wall surface and located farther from the opening, the inclined inner wall surface being expanded relative to the vertical inner wall surface; the outer periphery of the sealing portion is a vertical outer peripheral surface that closely fits against the vertical inner wall surface; and a sealing ring is located between the vertical inner wall surface and the vertical outer peripheral surface.

6. The fluid connector according to claim 1, wherein the fluid connector has a fixing component that holds the main body, allowing the main body to move in a radial direction perpendicular to the axial direction of the main body relative to the fixing component.

7. The fluid connector according to claim 6, wherein the shell has a flange integrally extending outward from the lower end of the main body, the fixing component is a fixing ring arranged around the main body, the fixing component includes a ring wall and an upper wall extending inward from the upper end of the ring wall, the flange is accommodated in the internal space formed by the ring wall and the upper wall, the ring wall is located outside the flange, and a gap is formed between the ring wall and the flange to allow the flange to move.

8. The fluid connector according to claim 7, wherein the fixing component of the fluid connector is fixed to a first plate by a holding element, the flange is clamped between the lower surface of the upper wall and the first plate by the holding element, and a sealing ring is located between the flange and the first plate.

9. A fluid connector assembly comprising:
a fluid connector comprising:
a shell having a main body with an internal cavity and a base integrally connected to the main body below the cavity, the main body having an opening formed upward and in communication with the cavity;
a valve body received in the shell; and
a valve body spring received in the cavity for supporting the valve body, one end of the valve body spring supporting the base and the other end supporting the valve body;
a fixing component arranged around the outside of the shell to hold the main body to a first plate and to allow the main body to move in a radial direction perpendicular to the axial direction of the main body relative to the fixing component; and
a matching connector comprising:
a matching shell having a matching cavity and a matching opening in communication with the matching cavity;
a matching push rod assembled to the matching shell, wherein the lower end of the matching push rod is fixed to the lower end of the matching shell;
a matching valve body assembled to the matching push rod and arranged around the upper end of the matching push rod; and
a matching spring housed within the matching shell and supports the matching valve body; wherein
when the fluid connector is not connected to the matching connector, the valve body is supported by the valve body spring and tightly clamped between the matching push rod and the matching shell; and
when the fluid connector and the matching connector are blindly mated, the main body is guided by the matching shell to move relative to the fixing component, causing the matching push rod to abut against the valve body and the main body to abut against the matching valve body, such that the valve body moves axially within the main body to open the opening and the matching valve body to move axially within the matching shell to open the matching opening.

10. The fluid connector assembly according to claim 9, wherein: the valve body has a sealing portion for sealing the opening and a cylindrical extension portion extending downward from a middle of the sealing portion; the base has an insertion hole for the extension portion to be inserted and move vertically therein; one end of the valve body spring supports the base and the other end supports the sealing portion; when the fluid connector is not connected to the matching connector, the sealing portion is pushed upward to seal the opening; and the lower end of the base is provided with a nut or a retaining ring fixed to the extension portion to restrict the sealing portion from detaching upward from the opening.

11. The fluid connector assembly according to claim 10, wherein: the matching push rod has a top portion at the upper end to closely fit with the sealing portion when the fluid connector is not connected to the matching connector, a bottom portion at the lower end, and a cylindrical rod portion connecting the top portion and the bottom portion; and the bottom portion has a matching through-hole in communication with the matching cavity, the matching shell has a boss that limits the upward movement of the bottom, and the lower end of the bottom is provided with a retaining ring clamped inside the matching shell to restrict the downward movement of the bottom.
